(19) United States
(12) Patent Application Publication
(10) Pub. No.: US 2014/0337598 A1
(43) Pub. Date: Nov. 13, 2014

(54) MODULATION OF FLASH PROGRAMMING BASED ON HOST ACTIVITY

(71) Applicant: LSI Corporation, San Jose, CA (US)

(72) Inventor: Vishwas Rao, Pleasanton, CA (US)

(21) Appl. No.: 13/932,219

(22) Filed: Jul. 1, 2013

Related U.S. Application Data
(60) Provisional application No. 61/820,252, filed on May 7, 2013.

(51) Int. Cl. G06F 3/06

(52) U.S. Cl. CPC G06F 3/0613; G06F 3/0635; G06F 3/0673
USPC 711/167

(57) ABSTRACT

An apparatus comprising a memory and a controller. The memory may be configured to process a plurality of read/write operations. The memory may include a plurality of memory modules each having a size less than a total size of the memory. The controller may be configured to (i) determine an amount of bandwidth used by the read/write operations, (ii) if the bandwidth is above a threshold value, process the read/write operations at a first speed, and (iii) if the bandwidth is below the threshold value, process the read/write operations at a second speed.

This application relates to U.S. Provisional Application No. 61/820,252, filed May 7, 2013, which is hereby incorporated by reference in its entirety.

### FIELD OF THE INVENTION

The invention relates to data storage generally and, more particularly, to a method and/or apparatus for implementing modulation of flash programming based on host activity.

### BACKGROUND

The useful life of a flash memory is a function of the number and/or intensity of program/erase operations. In particular, only so many program/erase operations can be made to each flash cell. When flash memory is used in a solid state drive (SSD), the number of program/erase operations tends to increase. As process technologies improve, the size of individual flash cells decreases. As cell sizes decrease, reliability of the cells decreases.

It would be desirable to reduce the effect of Program/Erase operations by slowing the program/erase operations when overall bandwidth usage or activity level is low.

### SUMMARY

The invention concerns an apparatus comprising a memory and a controller. The memory may be configured to process a plurality of read/write operations. The memory may include a plurality of memory modules each having a size less than a total size of the memory. The controller may be configured to (i) determine an amount of bandwidth used by the read/write operations, (ii) if the bandwidth is above a threshold value, process the read/write operations at a first speed, and (iii) if the bandwidth is below the threshold value, process the read/write operations at a second speed.

### BRIEF DESCRIPTION OF THE FIGURES

Embodiments of the invention will be apparent from the following detailed description and the appended claims and drawings in which:

FIG. 1 is a block diagram of a context of embodiments of the invention;

FIG. 2 is a more detailed diagram of the system of FIG. 1;

FIG. 3 is a diagram illustrating a host interface and a flash interface;

FIG. 4 is a diagram illustrating a modulation methodology; and

FIG. 5 is a diagram of a plurality of solid state drives implemented in the context of a drive array.

### DETAILED DESCRIPTION OF THE PREFERRED EMBODIMENTS

Embodiments of the invention include implementing a controller that may (i) be implemented in a solid state drive (SSD), (ii) provide modulation of flash programming speed based on host activity, (iii) determine host activity by monitoring activity on a channel, (iv) determine host activity by receiving hints from a host, and/or (v) be cost effective to implement.

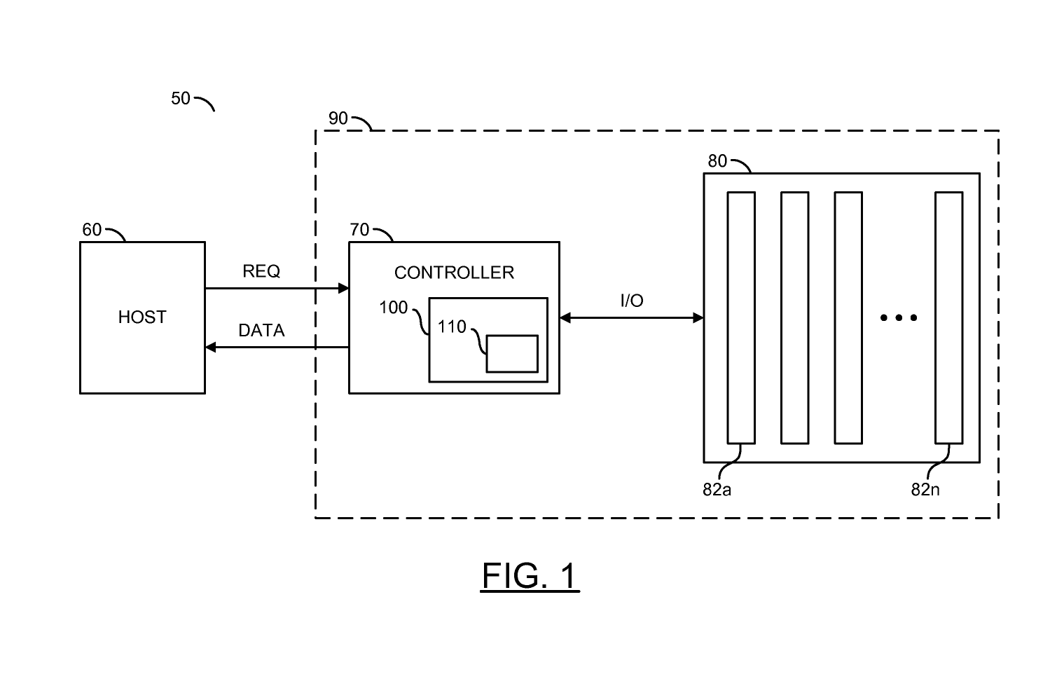

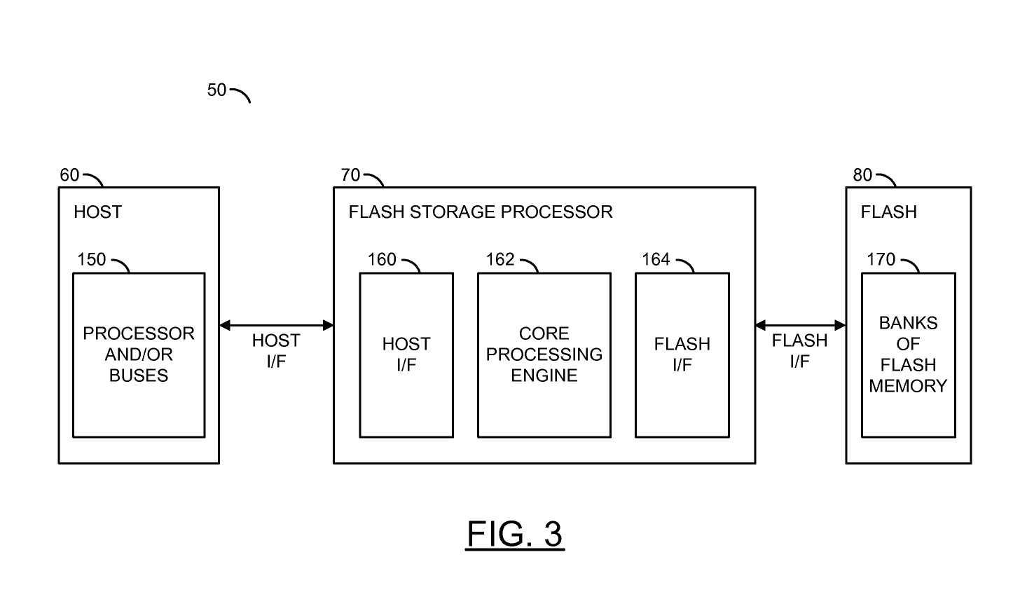

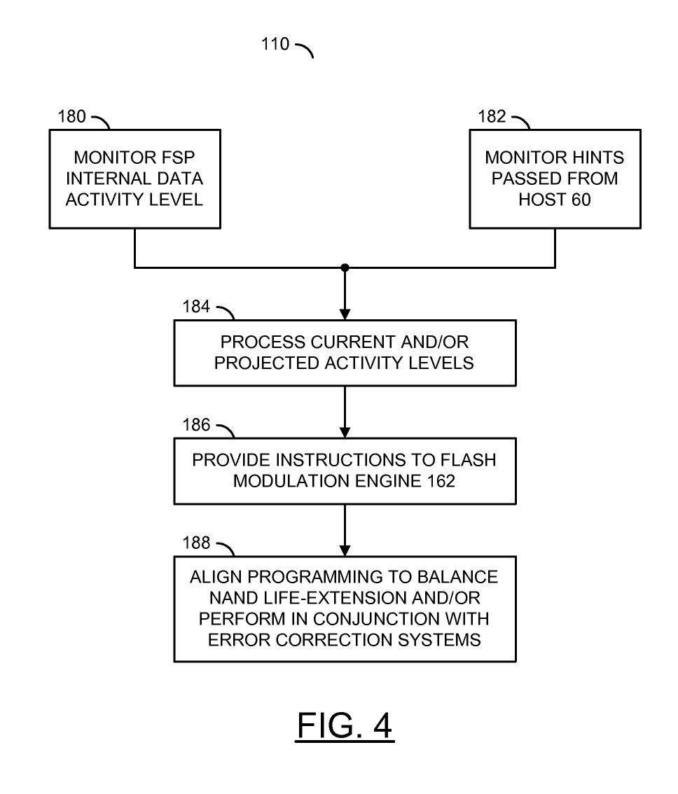

Referring to FIG. 1, a block diagram of an example apparatus 50 is shown. The apparatus 50 generally comprises a block (or circuit) 60, a block (or circuit) 70 and a block (or circuit) 80. The circuit 70 may include a circuit 100. The circuit 100 may be a memory/processor configured to store computer instructions (e.g., as firmware or hardware). The instructions, when executed, may perform a number of steps. The firmware 100 may include a control module 110 (to be described in more detail in connection with FIGS. 3 and 4). The control module 110 may be implemented as a write speed control module.

A signal (e.g., REQ) may be generated by the circuit 60. The signal REQ may be received by the circuit 70. The signal REQ may be a request signal that may be used to access data from the circuit 80. A signal (e.g., I/O) may be generated by the circuit 70 to be presented to/from the circuit 80. The signal REQ may include one or more address bits. A signal (e.g., DATA) may be one or more data portions received by the circuit 60. The controller 70 may include an I/O connecting circuit to implement multiple parallel channels.

The circuit 60 is shown implemented as a host circuit. The circuit 70 reads and writes data to and from the circuit 80. The host 60 may also read and write data to circuits and/or devices other than the circuit 80. The circuit 80 is generally implemented as a nonvolatile memory circuit. The circuit 80 may include a number of modules (or banks) 82a-82n. The modules 82a-82n may be implemented as NAND flash chips. In some embodiments, the circuit 80 may be a NAND flash device. In other embodiments, the circuit 70 and/or the circuit 80 may be implemented as all or a portion of a solid state drive 90 having one or more nonvolatile devices. The circuit 80 is generally operational to store data in a nonvolatile condition. When data is read from the circuit 80, the circuit 70 may access a set of data (e.g., multiple bits) identified in the signal REQ. The controller 70 may simultaneously access two or more of the modules 82a-82n through the multiple parallel channels.

In some embodiments, the circuit 80 may be implemented as a single-level cell (e.g., SLC) type circuit. An SLC type circuit generally stores a single bit per memory cell (e.g., a logical 0 or 1). In other embodiments, the circuit 80 may be implemented as a multi-level cell (e.g., MLC) type circuit. An MLC type circuit is generally capable of storing multiple (e.g., two) bits per memory cell (e.g., logical 00, 01, 10 or 11). In still other embodiments, the circuit 80 may implement a triple-level cell (e.g., TLC) type circuit. A TLC circuit may be able to store multiple (e.g., three) bits per memory cell (e.g., a logical 000, 001, 010, 011, 100, 101, 110 or 111).

The SSD drive 90 is shown containing multiple NAND Flash dies (or memory modules) 82a-82n. The dies 82a-82n may operate to read or to write concurrently. The read and write bandwidth depends on how many of the dies 82a-82n are implemented, as well as the bandwidth of each of the dies 82a-82n. If the SSD drive 90 receives a host command, in order to achieve the best performance and to address wear leveling issues, the drive 90 will walk through all of the dies 82a-82n (e.g., a first page of DIE0, DIE1 . . . DIEn, then a next page of DIE0).

In general, the controller 70 may include an erase/program unit implemented in an R-block (e.g., redundant) configuration (e.g., where data is stored in at least two locations to provide data security if one of the modules 82a-82n fails and/or malfunctions). For example, multiple blocks may be read from multiple dies 82a-82n. An erase/program unit may be implemented as part of the firmware 100.

The firmware 100 may be programmed to allow the useful life of the flash modules 82a-82n to be extended by adjusting the programming speed based on the level of host activity (e.g., host bandwidth demand). Extension of the life of the flash modules 82a-82n may be achieved by using slower/benign program/erase settings (e.g., lower pulse amplitude, longer programming time, etc.) to program the flash modules 82a-82n when the host 60 is not demanding much bandwidth. A slower programming speed normally presents less stress on the modules 82a-82n, which may extend the life of the modules 82a-82n. Faster program/erase settings may be limited to when the activity level on the host 60 (e.g., bandwidth demand) is high. A determination of a high or low activity on the host 60 may be generated, in one implementation, by comparing the measured activity with a predetermined threshold.

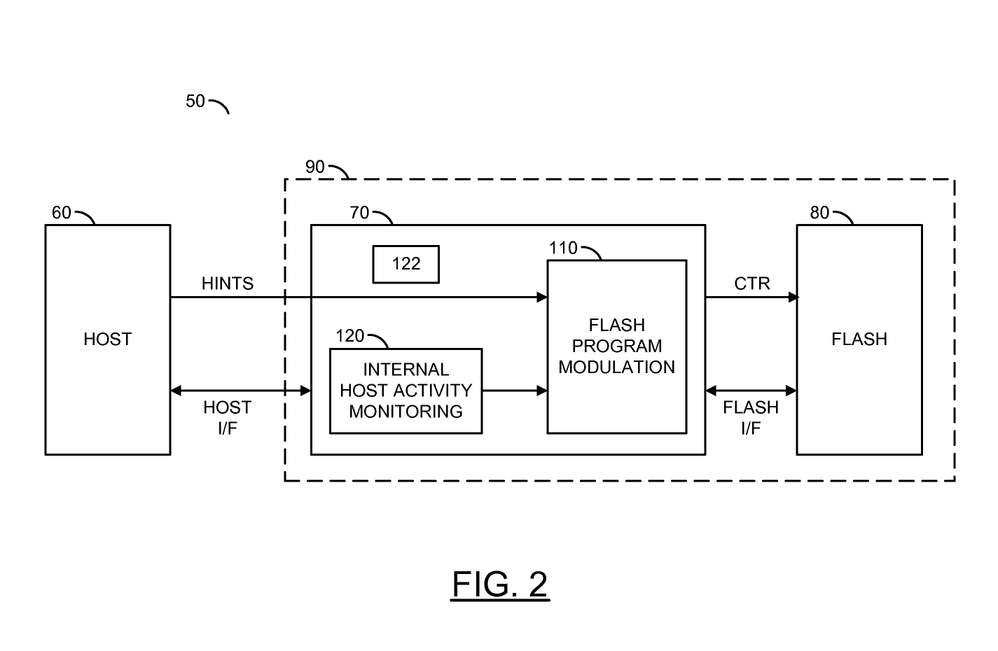

Referring to FIG. 2, a more detailed diagram of the system 50 is shown. Additional details of the controller 70 are shown. For example, the controller 70 shows the control unit implemented as a flash program modulation unit 110. The unit 110 receives a signal (e.g., HINTS) from the host 60. The signal HINTS provides an indication of the bandwidth between the host and/or the drive 90. Additionally, an internal host activity monitoring circuit 120 and a buffer 122 are shown. The circuit 120 may be used to provide a direct determination of the activity to/from the host 60.

The measurement of host activity level could be triggered and/or determined using a variety of procedures. For example, a number of predetermined activity thresholds may be triggered from within the flash storage processor (FSP) (or controller) 70. The controller 70 may monitor traffic/requests to/from the host 60 and/or to change (or modulate, adjust, etc.) flash-programming speed.

In another example, the selected write speed may be triggered from outside controller 70. For example, the host 60 may predictively instruct the controller about traffic patterns, causing the controller 120 to modulate the speed of the flash-programming. For example, if the buffer 122 in the controller 70 is full of data to write, and the host 60 sends a message that very little traffic is expected, the controller 70 may clear the buffer 122 slowly (e.g., programming flash modules 82a-82n with low amplitude pulses). The size of the buffer 122 may be varied to optimize and/or enable the controller 70 to adjust the program/erase operations effectively.

Various ways to determine the activity may be implemented. For example, on-the-fly (e.g., real time) measurements may be made. A predictive method may be used. Either hardware or software may be used. A driver may be implemented on the host 60 to send information to the controller 70. In one example, a finite state machine may be implemented. In one example, an operating system on the host 60 may predictively provide activity measurement.

The controller 70 may include one or more hidden modes to program the memory 80. Such hidden programming modes may often be used in test modes. The hidden programming modes may also be used to provide the modulation described.

Referring to FIG. 3, a diagram showing various details of the components of the system 50 is shown. The host 60 is shown including a block (or circuit) 150. The block 150 may be implemented as a processor and/or one or more buses. The controller 70 is shown implemented as a flash storage processor. The controller 70 generally comprises a block (or circuit) 160, a block (or circuit) 162, and a block (or circuit) 164. The circuit 160 may be implemented as a host interface. The circuit 162 may be implemented as a core processing engine. The circuit 164 may be implemented as a flash interface. The circuit 80 is shown including a block (or circuit) 170. The circuit 170 includes the flash banks 82a-82n.

Referring to FIG. 4, a flow diagram of a process for implementing the flash modulation block 110 is shown. The process 110 generally comprises a step (or state) 180, a step (or state) 182, a step (or state) 184, a step (or state) 186, and a step (or state) 188. The step 180 may monitor the internal data activity level of the controller 70. The step 182 may monitor the signal HINTS passed from the host 60. The step 184 may process current and/or projected activity levels. The step 186 may provide instructions to the flash modulation engine 162. The step 188 may align programming to balance the end life-extension and/or be performed in conjunction with one or more error correction systems.

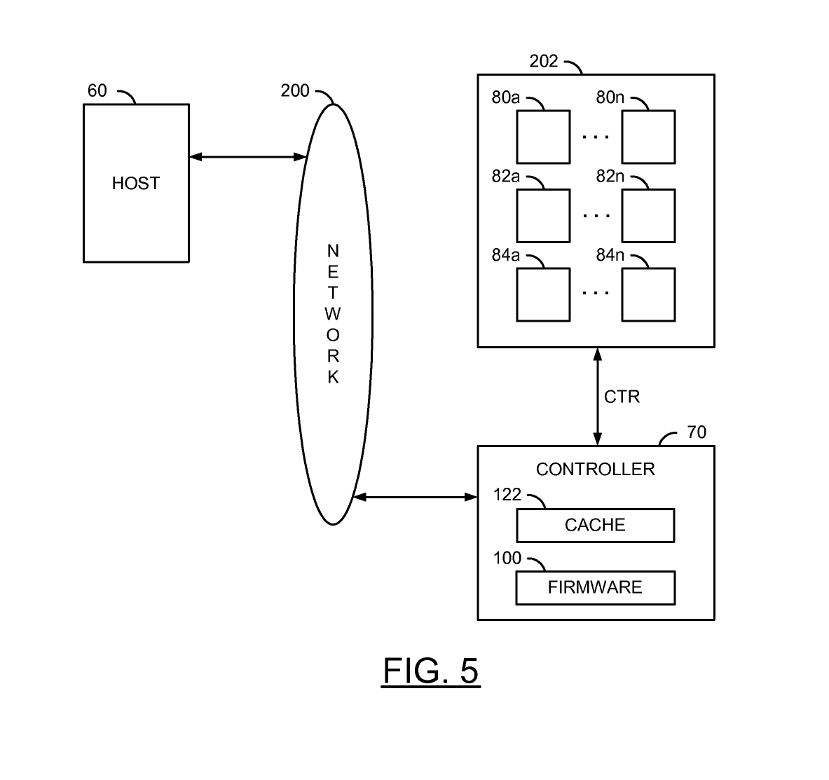

Referring to FIG. 5, an example of the controller 70 implemented in the context of an array 202 is shown. The controller 70 is shown connected to the host 60 through a network 200. The controller 70 may be implemented as a redundant array of inexpensive discs (RAID) controller. The array 202 is shown comprising a number of drives 80a-80n, 82a-82n and 84a-84n. One or more of the drives 80a-80n, 82a-82n and 84a-84n may be implemented as the flash device 80. The controller 70 may control the speed of write operations to one or more of the flash drives 80a-80n, 82a-82n and 84a-84n.

The terms “may” and “generally” when used herein in conjunction with “is(are)” and verbs are meant to communicate the intention that the description is exemplary and believed to be broad enough to encompass both the specific examples presented in the disclosure as well as alternative examples that could be derived based on the disclosure. The terms “may” and “generally” as used herein should not be construed to necessarily imply the desirability or possibility of omitting a corresponding element. As used herein, the term “simultaneously” is meant to describe events that share some common time period but the term is not meant to be limited to events that begin at the same point in time, end at the same point in time, or have the same duration.

While the invention has been particularly shown and described with reference to embodiments thereof, it will be understood by those skilled in the art that various changes in form and details may be made without departing from the scope of the invention.

1. An apparatus comprising:
a memory configured to process a plurality of read/write operations, said memory comprising a plurality of memory modules each having a size less than a total size of said memory; and
a controller configured to (i) determine an amount of bandwidth used by said read/write operations, (ii) if said bandwidth is above a threshold value, process said read/write operations at a first speed, and (iii) if said bandwidth is below said threshold value, process said read/write operations at a second speed.

2. The apparatus according to claim 1, wherein said first speed is configured to maximize bandwidth performance.

3. The apparatus according to claim 1, wherein said second speed is configured to minimize wear on the memory modules.

4. The apparatus according to claim 1, wherein said controller provides a plurality of threshold values and a plurality of speeds of operation depending on the determined bandwidth.

5. The apparatus according to claim 1, wherein said controller modulates a speed of flash programming based on said bandwidth.

6. The apparatus according to claim 5, wherein said modulation of said speed extends a lifetime of said memory modules.

7. The apparatus according to claim 1, wherein said determined bandwidth is based on activity detected on a host.

8. The apparatus according to claim 1, wherein said memory comprises non-volatile memory.

9. The apparatus according to claim 1, wherein said memory comprises flash memory.

10. An apparatus comprising:
a first interface configured to connect to a host device;
a second interface configured to connect to a plurality of memory modules each having a size less than a total size of said memory; and
a processor configured to (i) determine an amount of bandwidth used by read/write operations received from the host, (ii) if said bandwidth is above a threshold value, process said read/write operations at a first speed, and (iii) if said bandwidth is below said threshold value, process said read/write operations at a second speed.

11. The apparatus according to claim 10, wherein said processor provides a plurality of threshold values and a plurality of speeds of operation depending on the detected bandwidth.

12. The apparatus according to claim 10, wherein said second speed is configured to minimize wear on the memory modules.

13. The apparatus according to claim 10, wherein said memory comprises non-volatile memory.

14. The apparatus according to claim 10, wherein said memory comprises flash memory.

15. The apparatus according to claim 10, wherein said apparatus comprises a RAID controller configured to write to a plurality of drives.

16. The apparatus according to claim 10, wherein said processor provides two or more threshold values and two or more speeds of operation depending on the detected bandwidth.
